(19) United States
(12) Patent Application Publication
(10) Pub. No.: US 2017/0298493 A1
(43) Pub. Date: Oct. 19, 2017

(54) CLAD MATERIAL FOR ELECTRICAL TERMINAL CONNECTORS AND THE METHOD OF MAKING THE SAME

(71) Applicant: EMS Engineered Material Solutions, LLC, Attleboro, MA (US)

(72) Inventors: Joseph Mennucci, Mansville, RI (US); Michael D. Hardy, Cumberland, RI (US); Ronald R. Dos Santos, Hope Valley, RI (US); Donald G. McDonnell, Attleboro, MA (US)

(21) Appl. No.: 15/489,102

(22) Filed: Apr. 17, 2017

Related U.S. Application Data
(60) Provisional application No. 62/323,263, filed on Apr. 15, 2016.

(51) Int. Cl. C22F 1/08; H01M 2/30; H01R 4/62; C22F 1/04; H01R 43/16; B23K 20/02; B23B 35/00; B23K 103/18; B23K 101/38; B23K 103/10; B23K 103/12

(52) U.S. Cl. CPC C22F 1/08; B23K 20/02; H01M 2/305; H01R 4/62; C22F 1/04; B23B 35/00; H01R 43/16; B23K 2201/38; B23K 2203/10; B23K 2203/12; B23K 2203/18

(57) ABSTRACT

A method for producing a material that has the primary desirable properties that can be used for electrical terminal connectors. The present invention is directed at a clad material having high electrical conductivity, specific strength, good ductility, compatibility with joining materials, and low cost properties, and the method for making the material. In an aspect, the cladded material is made from one or more metals that collectively, have the properties discussed above. In an aspect, the cladded material is a transition-metal interconnector for electrical terminal connectors. In an exemplary aspect, the material is cladded aluminum and copper. The present invention relates to cladding materials built for use in connecting materials with different properties (e.g., aluminum and copper) in cathodes and anodes.

### CLAIM OF PRIORITY

This application claims priority from U.S. Provisional Patent Application No. 62/323,263, filed Apr. 15, 2016, which is incorporated herein in its entirety.

### FIELD OF THE INVENTION

The present invention relates to processes of cladding materials that can be used for electrical terminal connectors.

### BACKGROUND

Conventional electrical terminal connectors are commonly made of lead and are can be attached to a conductor during the casting operation by casting techniques. The conductor is inserted into the mold cavity of a die casting machine and the lead is injected around the end of the conductor in the shape of the connector. The primary desirable properties of these electrical terminal connectors for automotive electronics are high electrical conductivity, specific strength, good ductility, compatibility with joining materials, and low cost. This is especially the case for battery terminal connectors.

New developments in electrical engineering, i.e. Automotive Electro-Mechanical Drive Systems and Consumer Electronics, are utilizing Lithium-Ion, (Li-Ion), batteries. The construction of Li-Ion batteries typically have positive (+) aluminum and negative (−) copper terminals. Connection of these dissimilar metals in either series (multiple battery configurations of positive (aluminum) to negative (copper) configurations and/or parallel (multiple series connections to a main Busbar) configuration of either a positive (aluminum) terminal to mono-metal copper Busbar or negative (copper) terminal to an mono-metal aluminum Busbar all present a challenge for robust terminations.

Conventional joining techniques of mechanical fasteners of welding have resulted in either marginal or complete failures. There is need for better “transition-metal” interconnector. Some of the metals of interest for battery terminal connectors have one or more of the desirable properties, but typically not all of them. For example, mono-metal aluminum battery terminal connectors have good electrical conductivity, fair specific strength, good ductility, and low cost. Copper has excellent electrical conductivity, good specific strength, very good ductility, but poor joint compatibility and has a moderately high cost.

Therefore, there is a need for a transition material that has all of the desirable properties of electrical terminal connectors.

### SUMMARY OF THE INVENTION

The present invention is related to a method for producing a material that has the primary desirable properties that can be used for electrical terminal connectors. In an aspect, the present invention is directed at a clad material having are high electrical conductivity, specific strength, good ductility, compatibility with joining materials, and low cost properties, and the method for making the material. In an aspect, the cladded material is made from one or more metals that collectively, have the properties discussed above. In an aspect, the cladded material is a transition-metal interconnector for electrical terminal connectors. In an exemplary aspect, the material is cladded aluminum and copper.

The present invention relates to cladding materials built for use in connecting materials with different properties (e.g., aluminum and copper) in cathodes and anodes. The conducting cells can be interconnected by various welding and mechanical fastening techniques, and can streamline the cell module assembly process and increase reliability.

The present invention relates to a battery terminal connector construction. More specifically, the invention relates to means for the terminals of a storage battery of the type used in industrial applications and in automobiles so as to eliminate corrosion and improve performance of the terminals. The primary advantage of the clad metal product is the same metal-to-metal relationship between terminals and busbars/interconnector (e.g., copper to copper and aluminum to aluminum). In an aspect, the clad metal joint between the different metals of the interconnector is a hermetic metallurgical joint providing superior electrical and mechanical joining while sealing out the possibility of galvanic corrosion. The invention, in embodiments, also lengthens the life of the battery by holding the battery or groups of cells securely in position during use.

Numerous other embodiments are described throughout herein. All of these embodiments are intended to be within the scope of the invention herein disclosed. Although various embodiments are described herein, it is to be understood that not necessarily all objects, advantages, features or concepts need to be achieved in accordance with any particular embodiment. Thus, for example, those skilled in the art will recognize that the invention may be embodied or carried out in a manner that achieves or optimizes one advantage or group of advantages as taught or suggested herein without necessarily achieving other objects or advantages as may be taught or suggested herein. These and other features, aspects, and advantages of the present invention will become readily apparent to those skilled in the art and understood with reference to the following description, appended claims, and accompanying figures, the invention not being limited to any particular disclosed embodiment(s).

### BRIEF DESCRIPTION OF THE DRAWINGS

So that the manner in which the above recited features of the present invention can be understood in detail, a more particular description of the invention, briefly summarized above, may be had by reference to embodiments, some of which are illustrated in the appended drawings. It is to be noted, however, that the appended drawings illustrate only typical embodiments of this invention and the invention may admit to other equally effective embodiments.

FIGS. 1A-1E illustrate steps of a process for creating a cladded terminal connector, according to an aspect of the present invention.

FIGS. 2A-2E illustrate steps of a process for creating a cladded terminal connector, according to an aspect of the present invention.

FIGS. 3A-3C illustrate various boring or channeling options for the terminal connectors according to an aspect of the present invention.

FIGS. 4A-4C illustrate schematics of options for clad metal configurations, according to aspects of the present invention.

FIG. 5 illustrates a battery, according to an aspect of the present invention.

FIG. 6 illustrates a battery terminal and terminal connector, according to an aspect of the present invention.

FIG. 7 illustrates a method of stripping cladding, according to an aspect of the present invention.

FIG. 8 illustrates a metal strip configuration used to produce a heavy inlay ratio, according to an aspect of the present invention.

FIG. 9 illustrates an end view of the clad copper in aluminum after the stepped-bonded process, according to an aspect of the present invention.

FIG. 10 illustrates an end view of the clad copper in aluminum after the stepped-bonded process, according to an aspect of the present invention.

FIG. 11 illustrates individual electrical connectors machined from bonded clad metal strips, according to an aspect of the present invention.

FIG. 12 illustrates an individual electrical connector with apertures after machining, according to an aspect of the present invention.

FIGS. 13-14 illustrate bottom views of individual electrical connectors machined from a clad metal strip, showing selective metal removal to isolate the copper, according to aspects of the present invention.

FIGS. 15-16 illustrate clad metal strips with machined pockets to provide isolated copper regions, according to aspects of the present invention.

Other features of the present embodiments will be apparent from the Detailed Description that follows.

### DETAILED DESCRIPTION OF THE INVENTION

In the following detailed description of the embodiments, reference is made to the accompanying drawings, which form a part hereof, and within which are shown by way of illustration specific embodiments by which the invention may be practiced. It is to be understood that other embodiments may be utilized and structural changes may be made without departing from the scope of the invention. Electrical, mechanical, logical and structural changes may be made to the embodiments without departing from the spirit and scope of the present teachings. The following detailed description is therefore not to be taken in a limiting sense, and the scope of the present disclosure is defined by the appended claims and their equivalents.

A new process for creating a material for use in electrical terminal connectors is described herein. The present invention, in embodiments, is directed at a method for producing a material with primary desirable properties for electrical terminal connectors. In an aspect, the primary desirable properties include high electrical conductivity, specific strength, good ductility, compatibility with joining materials, and low cost. In an aspect, the material comprises cladding two or more metals that have some of these properties together.

Cladding dissimilar metals together is a method to attain multiple desirable metal properties in a single resulting product since each individual layer(s) will contribute to the bulk properties. In an aspect, the primary metal configuration cladded together is aluminum and copper. Aluminum brings to the clad metal the properties of good electrical and thermal conductivity, low weight, low cost, and moderate ductility along with the compatibility to be joined to aluminum battery terminals without concern for formation of detrimental metallurgical compounds which weaken the joint and increase electrical resistance. Copper brings to the clad metal the properties of excellent electrical and thermal conductivity, moderate cost, and good ductility along with the compatibility to be joined to copper battery terminals without concern for formation of detrimental metallurgical compounds which weaken the joint and increase electrical resistance. Therefore, cladding aluminum and copper together in a side-by-side configuration combines metals which optimize the electrical, thermal, metallurgical, and mechanical properties—while providing the most cost effective option. In an aspect, the copper is placed in an inlay clad option, with the aluminum surrounding the copper almost in its entirety.

The clad material method and resulting product discussed above offers the most basic bonding configuration(s) eliminating multiple processing requirements and offering a robust clad product. Other clad options require multiple bonding, annealing, and cleaning steps. Also, depending on the product requirements, the inlay clad option can minimize the amount of copper (the more expensive and higher density material), and maximize the amount of aluminum (i.e., the lower cost and less dense) to fill the volumetric space of the final product.

In an aspect, the ratio of aluminum to copper is dependent on the specific needs of the application. Generally, the terminal connectors require between 10% to 50% copper ratio by thickness. In an aspect, the copper needs to be located within the interconnector in the area connecting to the copper terminal/busbar. Conversely, the aluminum is located in the area connecting to the aluminum terminal or busbar. In an aspect, the inlay product can minimize the copper content by only locating the copper in a limited area specific to the connection interface.

In other aspects of the present invention, other combinations of dissimilar metals, including more than two metals, can be made into the terminal connectors discussed herein. In such aspects, the composition of the terminal connector is dependent on the specific application requirements. In one aspect, the copper and aluminum interconnector discussed above can include nickel on exposed copper surface to protect against corrosion, which facilitates laser welding. In another aspect, the terminal connectors can be a cladded material made of copper and nickel. In another aspect, the terminal connector can be a cladded material made with a copper core layer surrounded by a stainless steel outer layer. In exemplary aspects of the SS/CU/SS terminals, a nickel inter-layer can be utilized to enhance the bond strength between the stainless steel layers. As discussed above, the configuration of the metals and ratios is dependent on the specific application.

In some aspects, the cladded interconnector can also include over-molding, wherein thermal plastics are used to encapsulate the clad transition joints to prevent the potential of galvanic corrosion and provide custom mounting options. For example, in some thin-gauge Li-Ion battery tab products, a polyimide tape type film with adhesive can be used to encapsulate the clad joint of the copper to the aluminum.

In an aspect, the cladded product can be made by submitting the dissimilar materials to a bonding process. A number of different methods for cladding dissimilar metals can be utilized, including, but not limited to, cold roll bonding, pressure plate bonding, hot roll bonding, explosion bonding, and impact bonding. Regardless of the bonding process used, it is desirable that the metals be bonded in a matter that prevents intermetallic phases at the interface between the dissimilar metals. Roll bonding, both cold and hot, can be further broken down into sheet and continuous-coil bonding. Impact bonding, explosion bonding, and sheet roll bonding are all discrete processes that tend to be more expensive and less well suited to high production rates than continuous roll bonding. Any bonding process that utilizes applied heat in bonding is susceptible to creating detrimental intermetallic phases. Therefore, cold roll bonding and pressure plate bonding are considered to be low cost bonding processes with high productivity, which creates bonds without the formation of intermetallic phases at the interface.

The cold roll-bonding process bonds layers of metals together. In its conventional form, cold roll-bonding requires a significant amount of cold work be imparted in all of the layers being clad together, which significantly reduces the ductility of the clad metal. The reduction in ductility of the clad metal increases the hardness and mechanical strength. In order to regain the ductility, the clad metal is annealed in such a way that the each of the layers is annealed without creating detrimental intermetallic phases at the interface between the dissimilar metals. For metal combinations where each component anneals at similar temperatures, and intermetallic phases are not a concern, this is not much of a problem. In order to avoid this problem, the selection of the inter-liner layers along with controlling the processing parameters are done to minimize or totally eliminate the formation of detrimental intermetallic compounds. However, for metal clad configuration with heavy relative inlay layer thickness, (i.e. greater than 30% overall thickness), vertical edge bond strength is minimal at best due to the minimal transverse pressure generated in the vertical bonding interface during the cladding.

The minimal vertical edge-bond strength represents a possible product design limitation. Clad bonding produces high bond strength between horizontal material surfaces due to the extreme pressure generated during bonding. The vertical edge-bond is weak because the vertical material surfaces are not subjected to the extreme bond pressure—the material can displace “side-ways” between the mill rolls—because the material is not restricted; the tendency to spread minimizes the pressure on the vertical edge-bond. The minimal vertical edge-bond strength is inversely proportional to the inlay ratio thickness—heavy inlay ratio results in weaker vertical edge-bond strength and becomes very apparent if the finish connector has a bend/form in the area of the vertical edge. During forming the weak edge-bond can tend to separate and open along the seam.

Using an inlay or “stepped-material” clad technique (i.e., placing smaller layers in width on top of layers with greater width, or vice versa), shown in several of the figures, provides a significant improvement to the apparent strength of the vertical bond area, as well as an increase edge-bond strength, and electrical and thermal conductivity.

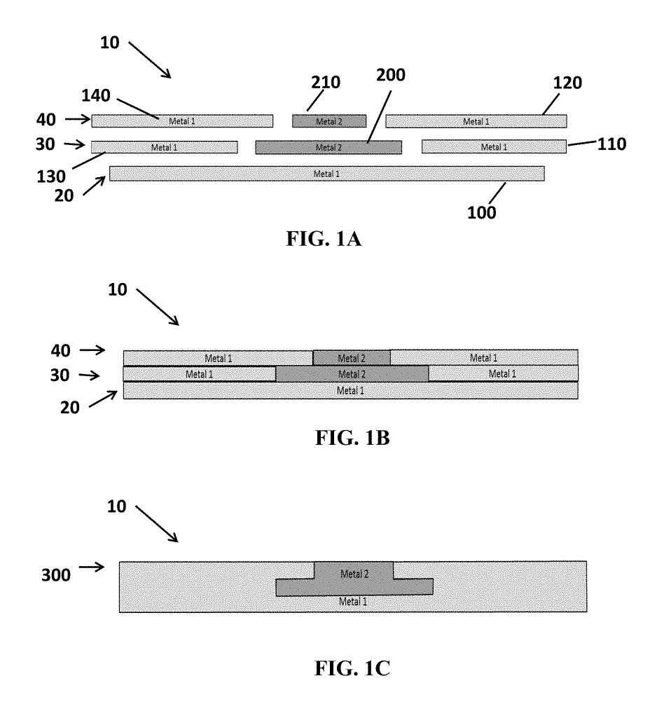

FIG. 1A-E show steps for making the cladded material 10, according to an aspect of the present invention. In step 1, shown in FIG. 1A, two separate metals (metal 1 and metal 2) are formed into a plurality of metal components. As illustrated, the metal components are prepared to form three layers 20, 30, 40 to make the ultimate cladded material 10. As shown in FIG. 1A, metal 1 is made of five components 100, 110, 120, 130, and 140, and metal 2 is made into two components 200, 210. Metal 1 components include a base component 100, two middle layer components 110, 130, and two top layer components 140. Metal 2 components include a middle layer component 200 and a top layer component 210. The base component 100 is formed to make the base layer 20 to support the other layers 30, 40. The middle layer 30 is made of a combination of two middle layer components 110, 130 of metal 1 and a middle layer component 200 of metal 2. The metal components 100, 110, 120, 130, 140, 200, and 210 are prepared for bonding using standard metalworking techniques, such as rolling, annealing, slitting, and cleaning. The metal components are cleaned, either chemically, mechanically, or both, to minimize or eliminate all organic and inorganic contamination to achieve acceptable bond strength between the clad layers. Other techniques may also be used.

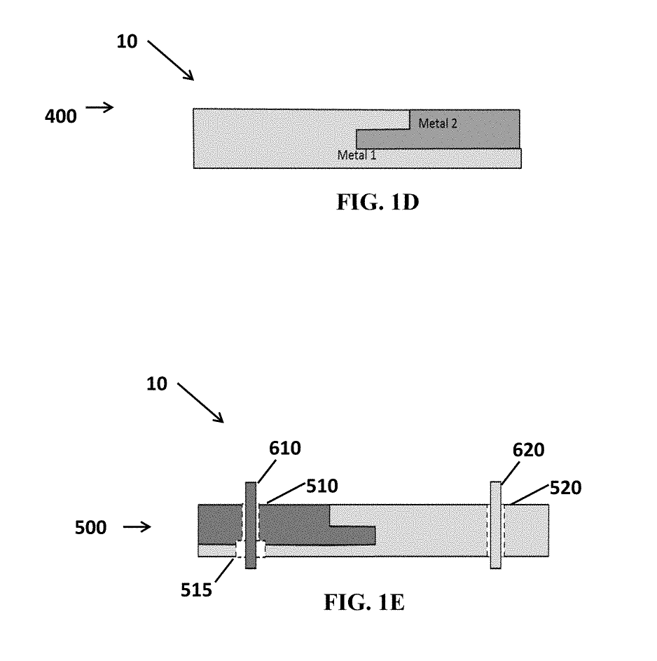

In step 2, shown in FIG. 1B, the individual metal components are positioned into bonds to create various configurations based on dimension and location of horizontal layers and vertical positions. In an aspect, the components are organized into three layers 20, 30, and 40. In an exemplary aspect, as shown in FIG. 1B, the top layer 40 is made of two top layer components 120, 140 of metal 1 and one top layer component 210 of metal 2. In an aspect, metal 2 components 200, 210 are positioned to be encased or surrounded by the metal 1 top and middle layer components 110, 130, 120, 140. Further, as shown, in a preferred embodiment, the size of the components of the middle and top layers vary in width so that these components can be arranged in a stepped, or overlapping, pattern, increasing the vertical edge-bond strength of the finished product 10. The step configuration is shown in FIG. 2B, where metal 2 is exposed at the top layer 40. Exposing metal 2 at the top layer allows the joining of the metal 2 of the battery terminal directly. Therefore, the top layer metal 2 allows for the metal 2 of the battery terminal to be welded with one another, and metal component 1 can be joined to the next adjoining cell with the matching metal component 1 battery terminal.

In step 3, shown in FIG. 1C, the configuration is roll bond to metallurgically clad the individual layers 20, 30, 40 (shown in FIG. 1B) and create a metal composite 300. Additional steps, such as annealing, can be performed after the roll bonding to enable specific finish material properties.

As shown in FIG. 1D, the clad metal composite 300 can then be processed to a finish strip size 400 using standard metalworking techniques, which include, but are not limited to, rolling, annealing, sliting, leveling, and the like. After the strip 400 is made, the clad metal strips 400 are processed into individual terminals using standard metal-forming techniques, such as stamping, water-jet cutting, laser cutting, and bonding. Standard metal removal techniques, such as mechanical milling, skiving, chemical etch, or other similar processes, can be used to expose internal layers in order to interact with battery terminals.

FIG. 1E shows a finished battery terminal connector 500 formed from the steps discussed above. As shown, the battery terminal connector 500 includes a first terminal aperture 510 and a second terminal aperture 520. The apertures 510, 520 are configured to receive a first and a second battery terminal 610, 620 of a battery, where the metal on the inner surface of the apertures matches the metal of the battery terminals. In an exemplary aspect, the first aperture 510 extends through substantially the first metal (metal 1) and the second metal (metal 2) and is configured to receive a battery terminal 610 made of the same metal (metal 2). In the same aspect, the second aperture 620 extends through the first metal (metal 1) and is configured to receive a battery terminal 620 made of the same metal (metal 1). In an aspect, the first aperture 510 can include a larger/wider opening 515 within the first metal (metal 1) to ensure that the first battery terminal 610 does not touch or come in contact with the first metal of the first aperture 510, preventing galvanic coupling that leads to corrosion.

FIG. 2A-E show another process for producing battery terminal connectors 1010, according to another aspect. In step 1, shown in FIG. 2A, four first metal (metal 1) components 1100, 1110, 1120, 1130 and one second metal (metal 2) components 1200 are made to form three layers 1020, 1030, and 1040 for the cladded material 1010. In an aspect, the metal components 1100, 1110, 1120, 1130, and 1200 are prepared for bonding using standard metalworking techniques, such as rolling, annealing, slitting, and cleaning, in order to achieve good alignment of the layers and proper surface conditions for a good, metallurgical bond. Other techniques may also be used.

As shown, the first metal components include a base layer 1100, two middle layer components 1110, 1120, and a top layer component 1130. The one second metal component 1200 is made to be placed in the middle layer 1030 between the middle layer components 1110, 1120 so that the second metal 1200 (metal 2) is completely surrounded by the first metal 1100, 1110, 1120, 1130 (metal 1) within the cladded material 1010. By eliminating the exposed edges of the core material (metal 2) 1200, the potential for corrosion is avoided. In an exemplary aspect, the first metal (metal 1) includes aluminum and the second metal (metal 2) includes copper. However, other combinations, as discussed above, are possible in other aspects.

In step 2, shown in FIG. 2B, the individual metal components can be positioned to create various configurations based on dimension and location of horizontal layers and vertical positions. As shown in FIG. 2B, the metal 2 component 1200 is surrounded by the first metal (metal 1) components 1100, 1110, 1120, 1130, with the base and top layer components 1100, 1130 completely overlapping the other components 1110, 1120, and 1200 to increase the vertical edge-bond strength once bonded in step 3 (FIG. 2C) and completely encase the first metal. This approach optimizes the bond strength for a more ridged construction, where the vertical wall is the weakest point in the structure.

In step 3, shown in FIG. 2C, the configuration is bonded to metallurgically clad the individual layers 1020, 1030, 1040 of the metal components and create a metal composite 1300. In an exemplary aspect, cold-roll bonding is used to bond the layers. Note that the dimensions of the composite can change. The clad metal strips can be processed into individual terminals using standard metal-forming techniques, such as stamping and bonding, as well as those discussed previously in regards to FIG. 1C. Standard metal removal techniques, such as mechanical milling, skiving, chemical etch, or other similar processes, can be used to expose internal layers.

As shown in FIG. 2D, a machined metal composite material 1400 is made. Bores 1410 are made in both the top and bottom layers of the first metal (metal 1) of the machined composite material 1400 that are adjacent to the second metal (metal 2). In an aspect, the bores 1410 extend to or partially into the second metal (metal 2) of the machined metal composite material 1400, leaving the second metal (metal 2) exposed at four locations. In an aspect, a total of 4 bores 1410 can be machined, two on the top and two on the bottom.

After the bores 1400 are made, the clad metal composite 1010 is processed to the finish strip 1500 size using standard metalworking techniques, such as rolling, annealing, slitting, and cleaning, as shown in FIG. 2E. In an exemplary aspect, the machined metal composite material 1400 is divided in half to create two portions, one of which is shown in FIG. 2E. Once sized correctly into strips, apertures 1510, 1520 can be driven through the strips, resulting in an electrical terminal connector 1500. The product of step 5 can be further machined or processed to produce this product. As shown, the battery terminal connector 1500 includes a first terminal aperture 1510 and a second terminal aperture 1520. The apertures 1510, 1520 are configured to receive a first and a second battery terminal 1610, 1620 of a battery, where the metal on the inner surface of the apertures 1510, 1520 matches the metal of the battery terminals 1610, 1620. In an exemplary aspect, the first aperture 1510 extends through the first metal (metal 1) and is configured to receive a battery terminal 1610 made of the same metal (metal 1). In the same aspect, the second aperture 1520 extends through both the first metal (metal 1) and second metal (metal 2) and is configured to receive a battery terminal 1620 made of the second metal (metal 2). In an aspect, the second aperture 1520 can include broader openings 1525, 1527 within the first metal (metal 1) to ensure that the second battery terminal 1620, made of metal 2, does not touch or come in contact with the first metal of the first aperture 1520, preventing galvanic coupling and potential corrosion.

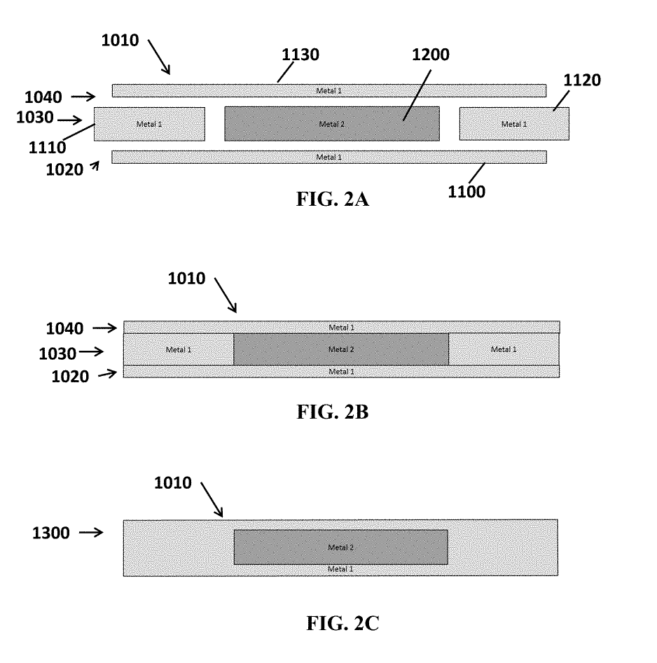

FIGS. 3A-C show various methods for producing channels or bores, according to embodiments of the invention. The channels/bores can be performed during mass production of the finished parts. The channeling and boring are different ways of removing the surface layer to expose the core material of the cladded material. FIG. 3A shows a two layer cladded connector 1700 comprising a first layer 1710 and a second layer 1720. In an exemplary aspect, the first layer 1710 comprises aluminum and the second layer 1720 comprises copper. As shown, counter bores 1715, 1725 are driven through both the top and bottom layers 1710, 1720, with bores 1715 driven through to the second layer 1720 from the first layer 1710 and counter bores 1725 driven through the second layer 1720 to the first layer 1715, exposing the core portion form both sides.

An example of use of such a connector follows: a main electrical connection coming from a battery module that has a copper terminal that needs to join along an aluminum bus bar. The attachment of the copper terminal can be a mechanical joint (bolt). The bolt connecting the copper terminal needs to be joined to copper—or risk a potential galvanic couple and corrosion (bolting the copper terminal directly to the aluminum bus bar). By removing material on the top and bottom layers, the opposite metals are exposed, enabling joining of the copper terminal to the copper and the aluminum terminal to the aluminum.

FIG. 3B shows an embodiment of cladded connector 1800 utilizing channels according to an aspect. As shown, the cladded connector 1800 includes a first layer 1810 of aluminum and a second layer 1820 of copper, wherein both layers included channels 1815, 1825 that extend through to the opposite layer.

FIG. 3C shows a cladded material 1900 made with several separate components connected in an overlay fashion (described above). As shown, 4 layers are made (1901, 1902, 1903, 1904). In this option, skived channels 1915 through to copper 1920 from the aluminum side 1910 are made. The dotted lines indicate the area that remains metallurgically bonded.

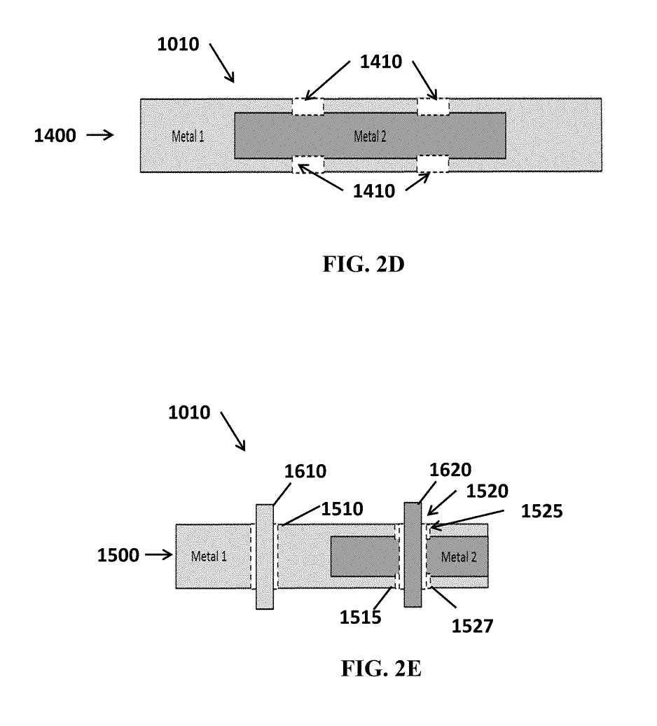

FIGS. 4A-C show multiple configurations of the cladded material with composition of the metals and sizes shown. In FIGS. 4A-C, various inlay sizes and material thicknesses are shown, according to embodiments. These options are not meant to be limiting, and other configurations are possible. Sixteen different options are described for the various types of metals and the dimensions of the metal. Options 1-4 (see FIG. 4A) show the cladded material with only two layers comprised of aluminum and copper, with the copper portion being an inlay within the top layer of aluminum. Options 5-10 (FIGS. 4A-4B) show the cladded material with three or more layers, wherein the bottom layer is comprised solely of just one metal, and the above layers comprising inlays of a second metal surround by the first metal. In such aspects, the second metal can be comprised of multiple layers, wherein the top layer of the second metal is smaller in width than the adjacent layer of the second metal beneath it. This can assist in creating a stronger vertical bond, as discussed above. Options 11-14 (FIGS. 4B-C) shown cladded material with three layers of two metals, the make-up of the layers similar to those discussed in relation to FIGS. 2A-E. Option 15 (FIG. 4C) illustrates a cladded material comprised of three layers and three metals, with the third metal (as shown, nickel) forming a cap in the top layer to cover the second metal, all supported by a solid bottom layer made of the first metal. Option 16 shows a top and bottom layer of a first metal (as shown, aluminum) that surround a middle layer made of a first metal encasing a second metal (copper) sandwiched between interliners made of a third metal (nickel).

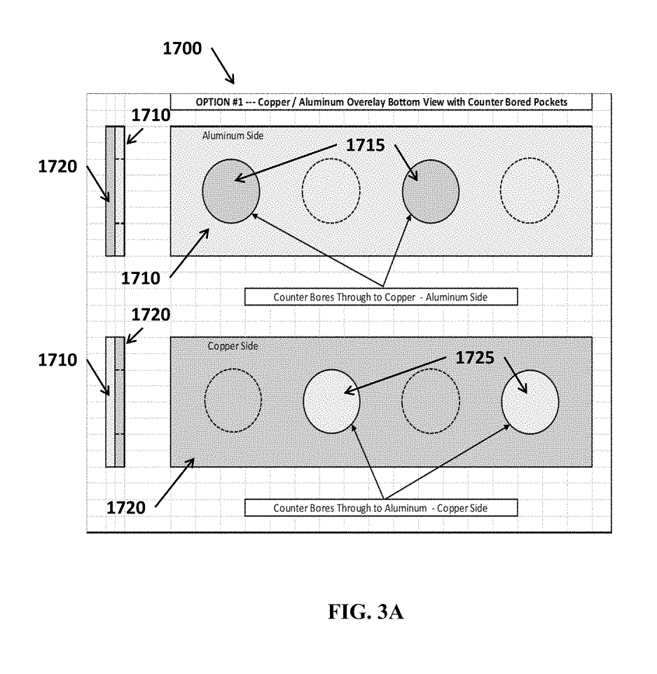

In an aspect, the process also includes selective metal removal as shown in the FIGS. 5-17, discussed below. Selective removal pertains to the idea of providing an electrical connector made from a multiple metal clad metal strip. The targeted applications, including lithium-ion batteries, typically have both copper and aluminum terminals. Joining these individual batteries in series and requires using unique connectors to avoid joining dissimilar metals because of potential for corrosion. Additionally, most welding techniques joining aluminum and copper form brittle intermetallic compounds, resulting in poor weld integrity.

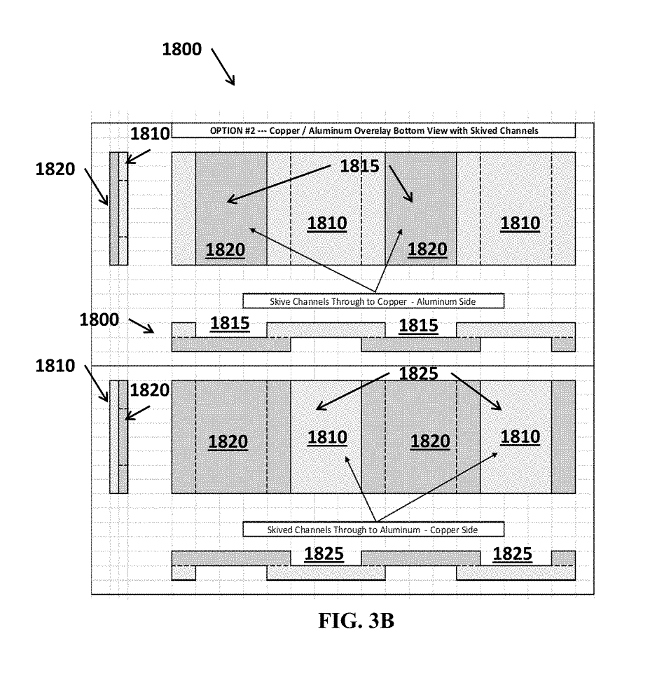

In FIG. 5 an embodiment of a terminal connector 2000 used on a battery assembly 2100 is shown. This connector 2000 enables the user to join the terminals—similar metal to similar metal—copper to copper and aluminum to aluminum. An embodiment of a connection 2000 of similar metals is shown in FIG. 6. The connectors 2000 shown above are used to connect batteries together in a series, when one battery anode 2105 is connected to the next battery cathode 2107. With the anodes 2105 and cathodes 2107 being of different material, the connectors 2000 described above have the different needed materials in one product.

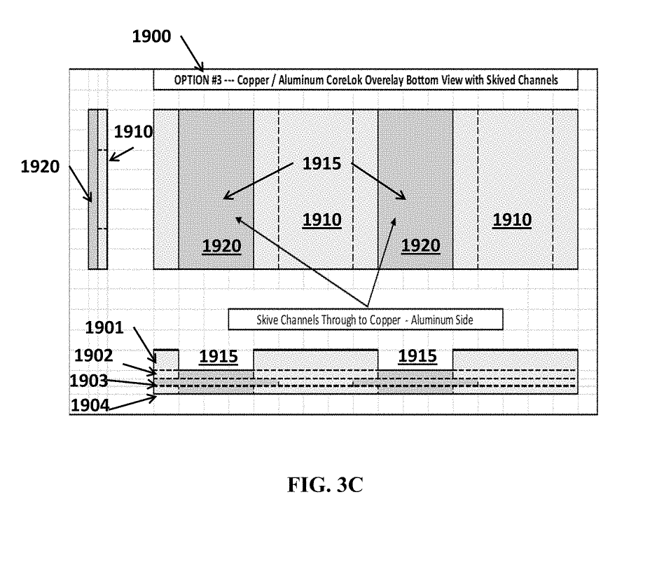

Selective metal removal can expose lower-layer and/or center-layer metal for isolation of dissimilar metals in the terminal contact region. The actual technique to selectively remove the metal layer to expose the “other” metal is not specific. A standard milling cutter can be used to machine away the aluminum layer to create the circular pockets. It is also possible to remove the metal layer selectively by skiving. The removal of the metal layer using skiving is shown in FIG. 7. This skiving is done using a stationary cutting tool and pulling the metal strip so as to cut the continuous ribbon of metal away. Another possible method would be to selectively etch away the area—using the appropriate chemicals and processing equipment. It should be noted that the selective metal removal as part of the part fabrication process is envisioned for many embodiments. A stamping press could incorporate a machine spindle to cut away the metal layer.

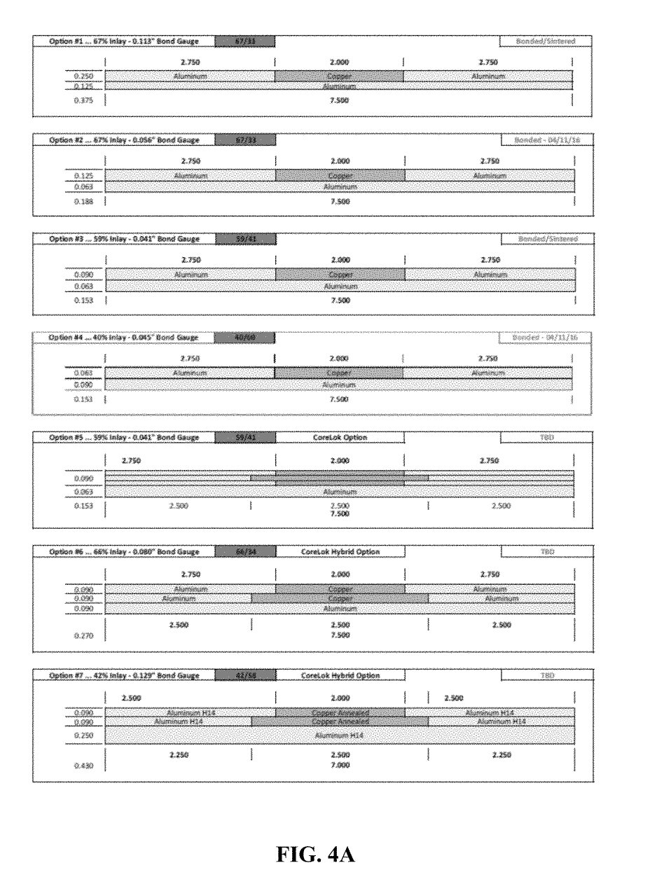

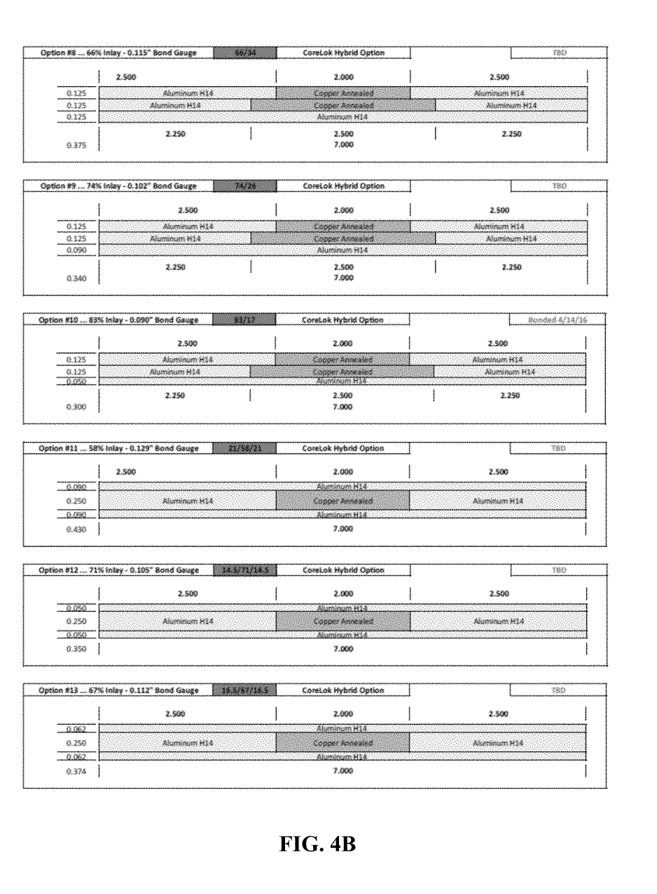

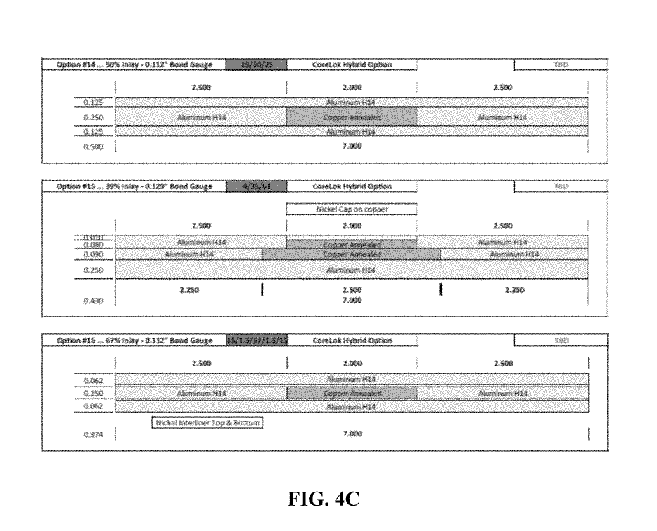

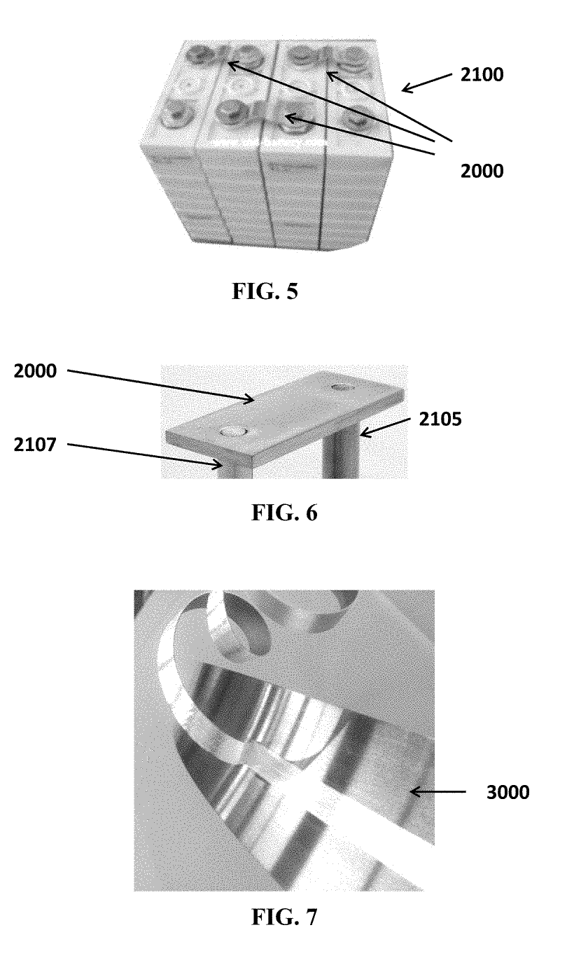

FIGS. 8-16 illustrate processes of making the cladded material 3000, according to embodiments of the present invention. FIG. 8 illustrates a metal strip configuration 3000. As shown, the metal strip configuration 3000 uses a heavy inlay ratio, with approximately 76% of the copper 3020 in aluminum 3010. FIGS. 9-10 show end views of the clad copper 3020 in aluminum 3010 after the stepped-bonded process discussed above. FIG. 11 shows individual connectors created by cutting a linear portion 3100 from the metal strip configuration 3000 and then dividing the linear portion 3100 to form two tabs 3150. The split can occur in the middle of the tab.

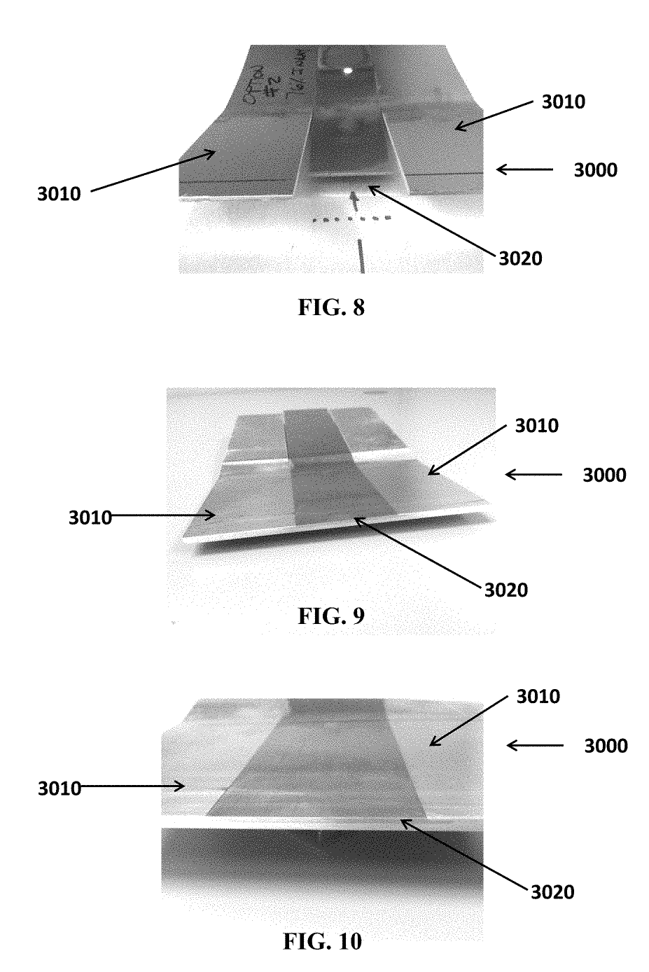

FIG. 12 shows the individual electrical connectors 4000 machined from the clad metal strip 3100, showing a selective metal removal to isolate the copper and/or aluminum. As shown, the individual connector 4000 includes apertures 4100, 4200 to receive the terminals of the battery.

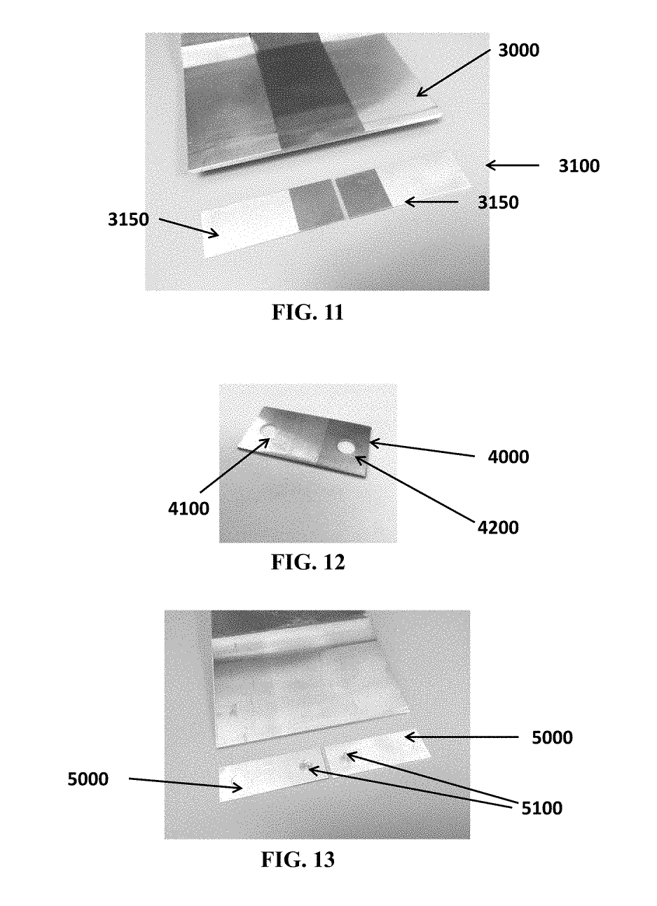

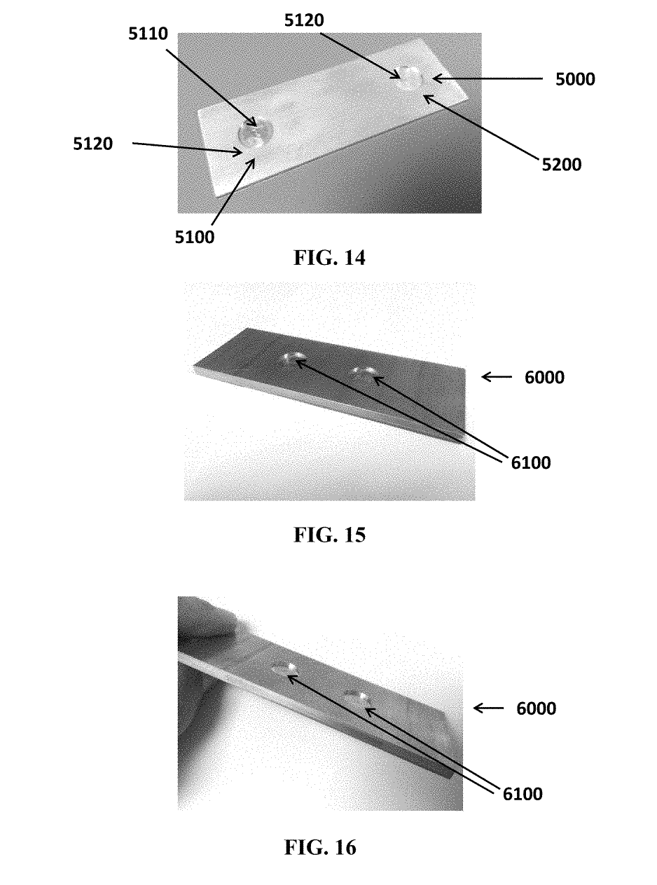

FIGS. 13-16 illustrate the clad metal strip with machined pockets, as opposed to apertures to provide isolated copper regions, according to embodiments. FIGS. 13-14 illustrate individual electrical connectors 5000 machined from a clad metal strip, showing selective metal removal (i.e., forming a bore) 5100 to isolate the copper 5110 from the aluminum 5120, and then forming an additional bore 5200 to receive an aluminum terminal, according to aspects of the present invention. FIGS. 15-16 illustrate clad metal strips 6000 with machined pockets 6100 to provide isolated copper regions, according to aspects of the present invention.

Having thus described exemplary embodiments of a method to produce metallic composite material, it should be noted by those skilled in the art that the within disclosures are exemplary only and that various other alternatives, adaptations, and modifications may be made within the scope of this disclosure. Accordingly, the invention is not limited to the specific embodiments as illustrated herein, but is only limited by the following claims.

In addition, while a particular feature of the teachings may have been disclosed with respect to only one of several implementations, such feature may be combined with one or more other features of the other implementations as may be desired and advantageous for any given or particular function. Furthermore, to the extent that the terms “including”, “includes”, “having”, “has”, “with”, or variants thereof are used in either the detailed description and the claims, such terms are intended to be inclusive in a manner similar to the term “comprising.”

Other embodiments of the teachings will be apparent to those skilled in the art from consideration of the specification and practice of the teachings disclosed herein. The invention should therefore not be limited by the described embodiment, method, and examples, but by all embodiments and methods within the scope and spirit of the invention. Accordingly, the present invention is not limited to the specific embodiments as illustrated herein, but is only limited by the following claims.

What is claimed is:

1. A method for creating electrical terminal connectors for batteries, comprising:
a. cladding a first metal together with a second metal to form a cladded material, wherein the first metal is different from the second metal, and wherein the first metal matches metal of an anode and the second metal matches metal of an cathode;
b. and applying a selective removal process from at least the first or the second metal of the cladded material in order to create electrical connections for the first metal with the anode and the second metal with the cathode.

2. The method of claim 1, wherein the electrical connections are made without galvanic coupling.

3. The method of claim 2, wherein the first metal is aluminum and the second metal is copper.

4. The method of claim 2, wherein the selective removal process comprises boring apertures in the cladded material.

5. The method of claim 3, wherein boring apertures comprises boring at least one aperture through both the first metal and the second metal and creating a wider aperture through the first metal than the second metal.

6. The method of claim 1, wherein the cladding the first and the second material together creates a greater vertical bond strength.

7. The method of claim 6, wherein the cladding comprises cladding the first metal with the second metal in a stepped pattern.

8. The method of claim 7, wherein the stepped pattern is formed from a plurality of metal components comprising the first and the second metals.

9. The method of claim 8, wherein the stepped pattern is formed by creating a first layer configured to be a bottom layer and a second layer supported by the top layer, wherein the first layer is formed from a first portion of the plurality of metal components comprised of the first metal, and wherein the second layer is formed from a second portion of the plurality of metal components, the second portion comprising at least three metal components comprising at least one second metal component surrounded by at least two first metal components in the second layer.

10. The method of claim 9, further comprising a third layer oriented above the second layer, the third layer made of a third portion of the plurality of metal components.

11. The method of claim 10, wherein the third portion consists of the first metal.

12. The method of claim 10, wherein the third portion comprises the first and the second metal, wherein the second metal is surround by the first metal and oriented substantially above the second metal of the second layer.

13. The method of claim 6, wherein the second metal is configured to be encased by the first metal.

14. The method of claim 6, wherein the cladding process comprises cold roll bonding the first and the second metals together.

15. The method of claim 1, wherein the cladding further comprises cladding the first metal and the second metal together with a third metal.

16. The method of claim 15, wherein the first metal comprises aluminum, the second metal comprises copper, and the third metal comprises nickel.

17. The method of claim 1, further comprising annealing the first metal and the second metal after the cladding, wherein the annealing fails to create detrimental intermetallic phases between the first metal and the second metal.

18. The method of claim 1, wherein before cladding the material, the first and the second metals are processed and cleaned.

19. The method of claim 1, wherein the first material comprises a majority of thickness of the electrical terminal connector.
